(19) United States
(12) Patent Application Publication
(10) Pub. No.: US 2009/0263254 A1
(43) Pub. Date: Oct. 22, 2009

(54) Ceiling Fan With High Efficiency Ceiling Fan Blades

(76) Inventor: John C. Bucher, Fort Lauderdale, FL (US)

Correspondence Address: Gray Robinson;ATTN: STEFAN V. STEIN/ IP DEPT., 201 N. Franklin Street, Suite 2200, Post Office Box 3324, TAMPA, FL, 33601-3324, US

(21) Appl. No.: 12/430,922

(22) Filed: Apr. 28, 2009

Related U.S. Application Data
(63) Continuation of application No. 11/430,260, filed on May 8, 2006.
Application No. 11/430,260 is a continuation-in-part of application No. 11/326,255, filed on Jan. 5, 2006, now abandoned.

(51) Int. Cl. F04D 29/38; F04D 25/02; B23P 15/04

(52) U.S. Cl. 416/229 R; 417/321; 29/889.71

(57) ABSTRACT

A ceiling fan including a motor having a rotatable rotor, a plurality of ceiling fans blades having a thickness, the blades connected to the rotor to rotate therewith and each of the ceiling fan blades comprising a thin edge along its leading edge that is thinner than the thickness of the ceiling fan blade to present less resistance and produce less turbulence and achieve high efficiencies.

### CROSS-REFERENCE TO RELATED APPLICATIONS

This application is a continuation of U.S. Ser. No. 11/430,260, filed May 8, 2006 which is a continuation-in-part application of U.S. Ser. No. 11/326,255, filed Jan. 5, 2006, the disclosures of which are hereby incorporated by reference herein.

### BACKGROUND OF THE INVENTION

1. Field of the Invention

This invention relates to ceiling fans. More particularly, this invention relates to ceiling fan blades having a high-efficiency design.

2. Description of the Background Art

Presently, there exist numerous types of ceiling fans designed to be suspended from a ceiling for circulating air flow within the room. Typically, ceiling fans comprise a plurality of ceiling fan blades which are operatively connected to an electric motor for rotating the fan blades to produce the desired air flow. The components of the ceiling fan, particularly the ceiling fan blades, are designed to optimize the amount of air flow being circulated per watt of energy consumed to thereby achieve high efficiencies.

The fan blades constitute one aspect of a ceiling fan which is an important factor in achieving high efficiencies. Ceiling fan blades commonly include an elongated planar or curvilinear structure having a proximal or root end which is coupled to a fan blade bracket which is, in turn, coupled to the rotor of the electric motor. The elongated planar fan blade is positioned by the fan blade bracket at an optimal angle (e.g., 11 to 17 degrees) to circulate air flow at high efficiencies.

Elongated planar ceiling fan blades are commonly manufactured of a medium-density fiber (“MDF”), laminated plywood, carved wood or plastic. More particularly, MDF fan blades are manufactured from large sheets of MDF wood that are pressed together to the desired thickness, typically 5.5 millimeters. The surface of the MDF sheets are protected by vinyl sheeting which are overlaid onto the MDF sheets and glued to the surface thereof (upper and lower) to form a watertight seal therewith. The MDF sheets are then positioned within a cutting machine which cuts out the individual ceiling fan blades from the MDF sheet in the desired pattern. The leading and trailing edges of the fresh-cut ceiling fan blade, as well as the tip and root ends of the fan blade, are then routed and sanded to produce a round edge with the vinyl extending thereto. Since the vinyl only extends up to the rounded edge, the rounded edge of the ceiling fan blade is then painted with a waterproof paint to seal the rounded edge so that moisture cannot penetrate into the rounded edge and seep underneath the vinyl sheet. Warpage of the fan blade, which would otherwise deteriorate the fan blade causing it to wobble, is therefore minimized.

Similar to MDF blades, plywood blades have been used for many years. Unlike MDF blades, plywood blades are typically lighter in weight, stronger and less likely to warp due to their cross grain construction and multiple plies. More particularly, conventional plywood commonly includes three plies of cross grain planar sheets of wood. During the manufacture of plywood fan blades, two sheets of the three ply plywood are glued to form a plywood sheet having six plies. The sheet of plywood is often covered with a vinyl material (upper and lower) that may include a solid color or a wood grain appearance. Alternatively, one or both sides of the plywood may be covered by a light colored paper. As in the case of manufacturing the MDF fan blades, the plywood sheets are then cut to the desired blade shape and their edges are routed and sanded to have a rounded edge. Similar to MDF fan blades, since the vinyl only extends to the rounded edges, the rounded edges are then painted with a waterproof sealant to preclude any ingress of moisture that might otherwise cause de-lamination of the plywood.

Plastic fan blades are most commonly used for outdoor fans and decorative fans, and may include a simulated wicker or rattan appearance. Plastic fan blades offer the advantage of being formed into curvilinear configurations, such as those shown in U.S. Pat. Nos. 6,659,721 and 6,039,541, the disclosures of which are hereby incorporated by reference herein. Unfortunately, however, since plastic is typically heavier than plywood or MDF, plastic fan blades result in higher resistance to the electric motor thereby necessitating increased torque. Moreover, due to gravity acting on the blades, the plastic blades must be thick enough to preclude them from warping or drooping over time. Consequently, plastic blades are often significantly thicker than their plywood or MDF counterparts. To reduce the likelihood of drooping, plastic blades may include a slightly raised center rib to add longitudinal strength.

The rounded edges of MDF blades, plywood blades and plastic blades present a thick edge. Consumers view the thick edge with appreciation because the thick rounded edge gives the ceiling fan an appearance of better quality. Unfortunately, however, the thick rounded leading edges of conventional fan blades produce a significant air resistance and turbulence as the ceiling fan blades are rotated through the air to cause the desired air flow. The increased resistance and turbulence along the leading edge of the thick rounded leading edge of the fan blade appreciably reduces the efficiency of the ceiling fan. In the case of the thicker plastic blades, even greater inefficiencies are often experienced.

Efforts to produce thinner blades that would correspondingly have thinner rounded edges, have met with little success since thinner blades do not have the necessary strength to function properly during continued use without droopage. Moreover, prior art techniques for “beveling” the leading edge of a ceiling fan blade, such as taught by Taiwan Patent Application 79200819, filed Jan. 22, 1990, the disclosure of which is hereby incorporated by reference herein, have not met with any commercial success. More particularly, beveling the leading edge of a ceiling fan blade such as taught by the Taiwanese patent application produces a relatively sharp knife edge that creates a hazardous condition in the event a person's hand or other object is moved into the path of the spinning fan blades. Indeed, industry safety regulations applicable to ceiling fans mandate that the leading edge of the fan blade must be greater than 3.30 millimeters thick so as to reduce the likelihood of injury should a person's hand or other object move into the path of the rotating fan blades. Similar to the Taiwanese patent, U.S. Pat. No. 5,554,006, the disclosure of which is hereby incorporated by reference herein, teaches a ceiling fan blade configuration having a concave blade periphery. However, this patent does not address the safety issues. See also design Pats. D507,644; D505,724; D503,795; D516,207; D516,208; D503,475; D503,476; D503,473; D503,472 and D503,474, the disclosures of each of which are hereby incorporated by reference herein.

As noted above, recent improvements to ceiling fan blade designs have been achieved by manufacturing the ceiling fan blades in a longitudinal curvilinear configuration as opposed to a longitudinal planar configuration. The curvilinear blade commonly includes a substantial angle (e.g. 30 degrees) at its root or proximal end connected to the ceiling fan blade bracket which gradually tapers to the more traditional angle of 11 to 17 degrees toward the distal end or tip of the fan blade. The airfoil configuration imitates the airfoil wing of an airplane for increased “lift” correspondingly to increase air flow when the airfoil configuration is employed as a ceiling fan blade. This curvilinear configuration increases air flow at the center portion of the fan more than what can be achieved by using planar fan blades. Unfortunately, like planar fan blades, curvilinear fan blades still produce appreciable resistance and turbulence along their leading edges.

There presently exists a need in the ceiling fan industry for improved ceiling fan blades that operate safely to achieve high efficiencies. Therefore, it is an object of this invention to provide an improvement which overcomes the aforementioned inadequacies of the prior art devices and provides an improvement which is a significant contribution to the advancement of the ceiling fan blade art.

Another object of this invention is to provide a ceiling fan having a high efficiency fan blade that meets industry-wide safety standards.

Another object of this invention is to provide a ceiling fan having a high efficiency fan blade that is protected from moisture by a vinyl or other coasting applied to its surfaces and to at least a portion of its edges.

Another object of this invention is to provide a ceiling fan having upper and/or lower surfaces of the ceiling fan blades covered by suitable decorative and/or protective sheeting, such as vinyl or paper sheeting that extends all the way out to cover at least a portion of the thin leading edge with the exposed uncovered portion of the thin leading edge coated with a sealant to prevent moisture intrusion.

Another object of this invention is to provide a ceiling fan having upper and/or lower surfaces of the ceiling fan blades covered by suitable decorative and/or protective sheeting, such as vinyl or paper sheeting that extends all the way out and around the thin leading edge, thereby precluding the necessity for a sealant coating since there are no exposed uncovered portion that may otherwise absorb moisture.

Another object of this invention is to provide a ceiling fan having upper and/or lower surfaces of the ceiling fan blades covered by suitable decorative and/or protective sheeting, such as vinyl or paper sheeting that presents an extremely aesthetically clean appearance to the consumer over what would otherwise be observed by the consumer if the thin leading edge was not at all covered by the sheeting.

The foregoing has outlined some of the pertinent objects of the invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY OF THE INVENTION

For the purpose of summarizing this invention, this invention comprises a ceiling fan having high efficiency fan blades. More particularly, several embodiments of the high efficiency fan blades of the invention each comprise a thin-edge configuration that effectively reduces thickness of the leading edge of prior art ceiling fan blades such that the thinner leading edge of the invention presents less resistance and produces less turbulence than thicker prior art fan blade edges. The thin-edge fan blades of the invention therefore result in high efficiencies.

More particularly, one embodiment of the high efficiency ceiling fan blades of the invention comprises a generally planar or curvilinear elongated configuration (MDF, plywood, carved wood or plastic) with a reduced-thickness or thin leading edge. In one variation, the thin leading edge achieves a leading edge thickness equal to or appreciably greater than the industry standard minimum thickness. The thin leading edge then gradually tapers or steps into the thickness of a conventional MDF, plywood or plastic blade. The thin leading edge is preferably centered relative to the usual thickness of the blade. Alternatively, however, the reduced-thickness edge may be positioned at one surface of the fan blade, preferably the lower surface.

Importantly, the thin leading edge of the invention is easily adapted to all types of ceiling fan blades that are currently being manufactured. For example, in the case of plastic fan blades, the thin edge design of the invention may be easily injection molded. In the case of plywood fan blades and MDF fan blades, the edge of the fan blade may be easily routed to the desired thin edge design and then sealed with a waterproof sealer painted onto the exposed edges.

In another embodiment of the high efficiency ceiling fan blades of the invention, the upper surface of the ceiling fan blades may comprise a generally apex configuration defined by two planar surfaces formed at an angle leading from the opposing thin leading edges across the width of the fan blade to form an apex along a center line of the fan blade. Importantly, the thickness of the fan blade at the thin leading edges comprises a reduced thickness which is equal to or appreciably greater than the minimum thickness mandated by applicable ceiling fan safety regulations. It is noted that the thin leading edge of this embodiment of the invention is contemplated to be principally formed by plastic injection molding or through carved fan blades due to the angles involved that could not typically be achieved through the use of laminated plywood or MDF. Indeed, this second embodiment is particularly desirable for implementation with decorative plywood or carved wood fan blades that would normally require significant sanding or carving to achieve the desired decorative designs. Moreover, the apex configuration provides strength along the longitudinal length of the fan blade thereby reducing the likelihood of drooping due to gravity over extended periods of non-use.

In still another embodiment of the high efficiency ceiling fan blades of the invention, the upper and/or lower surfaces of the ceiling fan blades may be covered by suitable decorative and/or protective sheeting, such as vinyl or paper sheeting. According to the invention, the sheeting is adhesively applied to one or both of the surfaces (i.e., upper and/or lower) of the fan blade by an adhesive or the like. The sheeting extends, in one embodiment, all the way out to cover at least a portion of the thin leading edge. The exposed uncovered portion of the thin leading edge is then coated with a sealant to prevent moisture intrusion. Whereas, in another embodiment, the sheeting extends all the way out and around the thin leading edge, thereby precluding the necessity for a sealant coating since there are no exposed uncovered portion that may otherwise absorb moisture. If similar sheeting is also applied to the other surface of the ban blade, the last-applied sheeting may extend all the way out and around the thin leading edge as to overlap the corresponding sheeting previously applied to the other surface.

In both of these embodiments, the sheeting protects all or substantially all of the thin leading edge of the fan blade from moisture intrusion along the thin leading edge that would otherwise potentially result in swelling or warping of the fan blade. It is noted that in the embodiment in which the sheeting does not wrap around the thin leading edge to overlap similar sheeting on the other side, the exposed rounded leading edge of the fan blade is nevertheless coated with moisture-barrier paint or the like, thereby precluding moisture instruction along the thin edge of the blade. In both embodiments, the fact that the sheeting extends over all, or at least a significant portion of the edge, presents an extremely aesthetically clean appearance to the consumer over what would otherwise be observed by the consumer if the thin leading edge was not at all covered by the sheeting.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is a side elevational view of the ceiling fan of the invention with its thin edge ceiling fan blades;

FIG. 2 is a transverse cross-sectional view of a conventional MDF ceiling fan blade showing the planar construction thereof, the laminated vinyl material to the opposing surfaces thereof and the waterproof sealant painted onto the leading and trailing edges thereof;

FIG. 3 is a transverse cross-sectional view of FIG. 1 of the thin edge ceiling fan blade of the first embodiment of the invention along lines 30-30 thereof as viewed toward the root of the fan blade;

FIG. 4 is a is a transverse cross-sectional view of the second embodiment of the invention;

FIG. 5 is a transverse cross-sectional view of the third embodiment of the invention;

FIG. 6 is a transverse cross-sectional view of the fourth embodiment of the invention;

FIG. 7 is a transverse cross-sectional view of the fifth embodiment of the invention;

FIG. 8 is a transverse cross-sectional view of the sixth embodiment of the invention as viewed toward the tip of the fan blade;

FIG. 9 is a transverse cross-sectional view of the seventh embodiment of the invention;

FIG. 10 is a is a transverse cross-sectional view of the eighth embodiment of the invention;

FIG. 11 is a transverse cross-sectional view of the ninth embodiment of the invention;

FIG. 12 is a transverse cross-sectional view of the tenth embodiment of the invention;

FIG. 13 is a transverse cross-sectional view of the eleventh embodiment of the invention;

FIG. 14 is a transverse cross-sectional view of the twelfth embodiment of the invention as viewed toward the tip of the fan blade;

FIG. 15 is a transverse cross-sectional view of the thirteenth embodiment of the invention;

FIG. 16 is a is a transverse cross-sectional view of the fourteenth embodiment of the invention;

FIG. 17 is a transverse cross-sectional view of the fifteenth embodiment of the invention;

FIG. 18 is a transverse cross-sectional view of the sixteenth embodiment of the invention;

FIG. 19 is a transverse cross-sectional view of the seventeenth embodiment of the invention;

FIG. 20 is a transverse cross-sectional view of the eighteenth embodiment of the invention as viewed toward the tip of the fan blade;

FIG. 21 illustrates the method of the invention for manufacturing one or more of the embodiments of the invention disclosed in FIGS. 3-20, showing the manner in which the sheeting is applied to at one surface of the fan blade;

FIG. 22 illustrates the method of the invention for manufacturing one or more of the embodiments of the invention disclosed in FIGS. 3-20, showing the manner in which the applied sheeting is pressed onto the surface of the fan blade to assure adequate adherence to the surface thereof and to at least a portion of the thin edge thereof;

FIG. 23 illustrates the method of the invention for manufacturing one or more of the embodiments of the invention disclosed in FIGS. 3-20, showing the use of automatic or hand side rollers for further assuring that the sheeting is fully adhered to the thin edge of the fan blade;

FIG. 24 illustrates the method of the invention for manufacturing one or more of the embodiments of the invention disclosed in FIGS. 3-20, showing the manner in which the excess sheeting is sanded from edge of the ceiling fan; and

FIG. 25 illustrates the method of the invention for manufacturing one or more of the embodiments of the invention disclosed in FIGS. 3-20, showing the manner in which the excess sheeting is cut from edge of the ceiling fan.

Similar reference characters refer to similar parts throughout the several views of the drawings.

### DETAILED DESCRIPTION OF THE PREFERRED EMBODIMENT

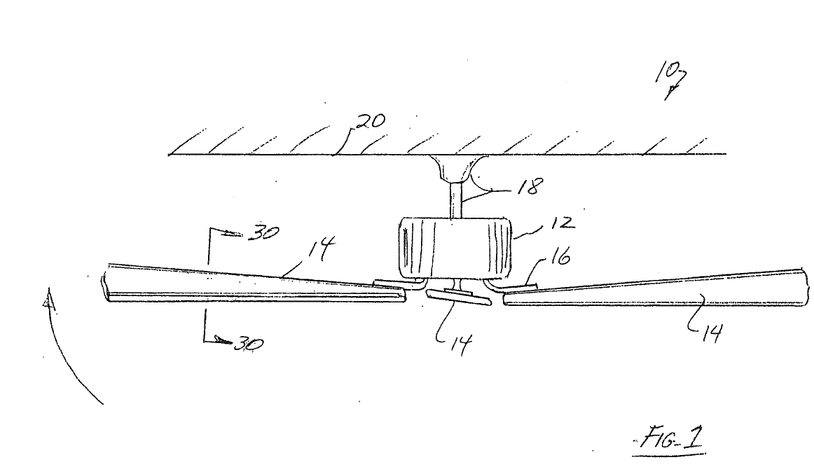

FIG. 1 is a side elevational view of a conventional ceiling fan 10 comprising an electric motor assembly 12 and a plurality of ceiling fan blades 14 connected to the rotor of the motor assembly 12 by means of ceiling blade brackets 16. The ceiling fan 10 is intended to be connected by means of a hanger and down rod assembly 18 to the ceiling 20 of a room. During operation in one direction, the rotating ceiling fan blades 14 circulate air downwardly from the ceiling 20 (typically during summer months). During operation in the reverse direction, the rotating ceiling fan blades 14 circulate air upwardly toward the ceiling 20 (typically during winter months). In either direction, the objective is to create a circulatory flow of air throughout the room to thereby reduce energy costs.

FIG. 2 is a cross sectional view of a conventional ceiling fan blade 16 manufactured from an MDF material. More particularly, an MDF fan blade 16 comprises a generally planar elongated configuration having a width “W” and a thickness “T₁” composed of an MDF laminate 18. Commonly, a sheet of a vinyl material 20 is adhered to the upper and lower surfaces of the MDF material 18. The sheeting material 20 may comprise many different colors and/or decorative appearances such as wood grains. The longitudinal edges 22 are routed to a bull nose configuration and sanded smooth. Since the sheeting 20 thus extends up to but not over the bull nose rounded longitudinal edges 22, the bull nose rounded longitudinal edges 22 are then sealed by painting them with a waterproof sealant 24. It is noted that when employing plywood instead of MDF, a similar procedure is used to route the bull nose rounded edges 22 that are then sealed with the sealant 24 painted thereon. In the case of plastic fan blades that are injection molded, the vinyl sheeting 20 may alternatively comprise a sheeting of paper material which too may comprise a variety of colors or decorative designs such as a wood grain.

The first of the many embodiments of the invention are now described in relation to FIGS. 3-8. More particularly, each of these embodiments of the invention of FIGS. 3-8 comprises a ceiling fan blade 30 manufactured by any available manufacturing technique such as methods for producing MDF blades, plywood blades, plastic blades or carved blades, to create a generally planar or curvilinear fan blade 30 having a thickness T₁. At least the thin leading edge 32 and alternatively also the trailing edge 34 comprise a reduced thickness T₂ which is appreciably thinner than the thickness T₁ of the fan blade 30. The thin leading edge 32 of thickness T₂ more preferably equals or exceeds the applicable safety standard that defines the minimum thickness for ceiling fan blades.

As shown in FIGS. 3 and 4, the thin leading edge 32 of the fan blade 30 of the invention is positioned in the middle of the thickness T₁ of the blade 30. As shown in FIG. 3, the angled edge portion comprising the transition between the thin leading edge 32 and the opposing surfaces 30U and 30L of the fan blade 30 comprises a concave step 36 which blends into a rounded edge portion 32 whereas in FIG. 4, the angled edge portion comprising the transition comprises a generally planar transition 38 which blends into a rounded edge portion 32. In both embodiments of FIGS. 3 and 4, the rounded edge portion 32 may be sanded or chamfered to eliminate any sharp corners between the transitions 36 and 38 and the thin leading edge portion 32.

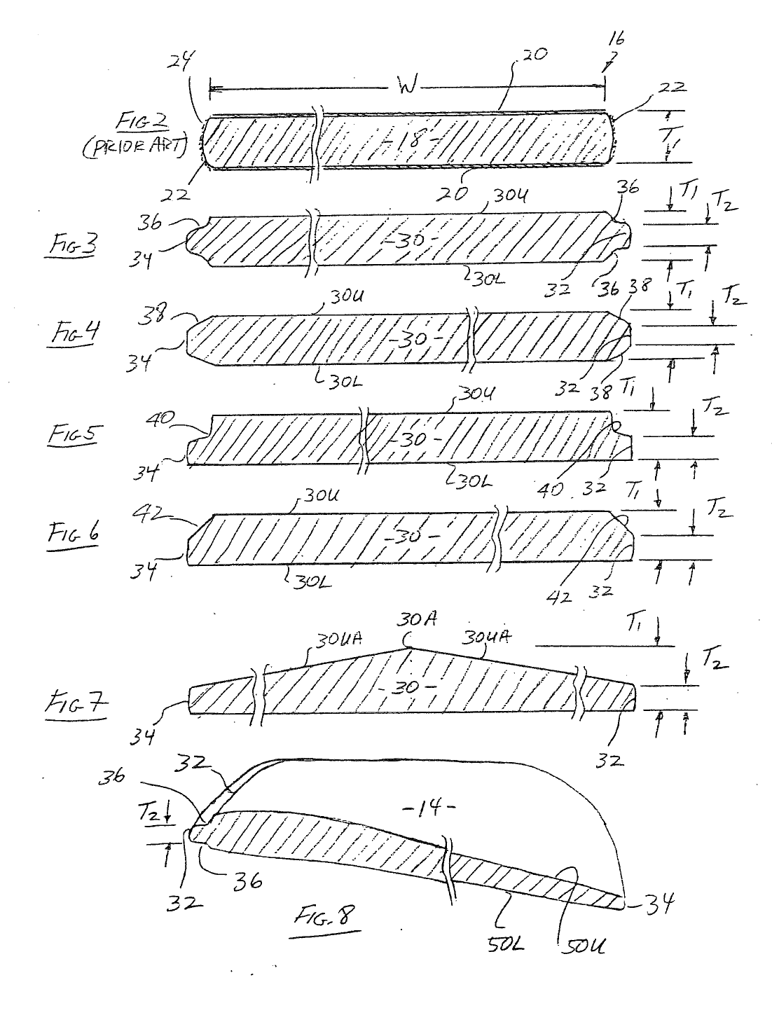

As shown in FIGS. 5 and 6, the rounded edge portion 32 is positioned closer to the bottom surface 30L of the fan blade 30 rather than being positioned midway as shown in the previous embodiments of FIGS. 3 and 4. More particularly, as shown in FIG. 5, the angled edge portion comprising the transition between the rounded edge portion 32 and the upper surface comprises a stepped configuration 40 whereas the angled edge portion comprising the transition in FIG. 6 comprises a generally planar transition 42. As in the case of embodiments of FIGS. 3 and 4, the rounded edge portion 32 may be sanded or chamfered to break any sharp edges that might otherwise occur with the respective transitions 40 and 42.

As noted above, the trailing edge 34 of the ceiling fan blade 30 of the invention may likewise comprise a thin edge 32 of one of the embodiments described above. The double thin edge embodiments are particularly useful in the event the ceiling fan 10 will be operated in a reverse direction whereupon the blades rotate in reverse thus the former trailing edge becomes a leading edge, and vice versa. Furthermore, without departing from the spirit and scope of the invention, it should be appreciated that one embodiment of the rounded edge portion 32 may be used with any of the other embodiments. Finally, it is noted that the embodiments of FIGS. 3 and 4 are the same whether or not the blades are installed upside down in reverse whereas the embodiments of FIGS. 5, 6 and 7 are not contemplated to be reversible.

As shown in FIG. 7, still another embodiment of the thin edge ceiling fan blade 30 of the invention comprises a generally apex configuration wherein the upper surface 30U of the fan blade comprises two angled surfaces 30AU extending from opposing thin leading edges 32 and 34 to a longitudinal apex 30A, preferably positioned at or proximate to the longitudinal center of the fan blade 30.

The longitudinal apex 30A of the fan blade 30 according to this embodiment produces increased structural integrity along the longitudinal length of the fan blade 30 to further reduce wobbling or drooping over time.

The foregoing embodiments of FIGS. 1-6 were shown as generally planar ceiling fan blades 14 with its opposing surfaces being generally parallel to each other. However, as shown in FIG. 8, any of the thin edge embodiments of FIGS. 1-6 may be incorporated into the leading edge 32 of curvilinear ceiling fan blades 14 such as those of U.S. Pat. Nos. 6,039,541 and 6,659,721, previously incorporated by reference herein.

More particularly, as shown in FIG. 8, a curvilinear ceiling fan blade 14 comprises an airfoil 50 composed of an upper surface 50U and a lower surface 50L that produces a lifting force when rotated. Furthermore, a curvilinear fan blade 14 often comprises an increasing “twist” formed along its elongated configuration from its tip to its root, such that, preferably, the same volume of airflow is achieved along its entire length even though the tip of the blade 14 is moving faster than its root. The incorporation of the thin leading edge 32 of the invention into curvilinear fan blades 14 increases the efficiency by reducing resistance and turbulence.

FIG. 9 illustrates the seventh embodiment of the ceiling fan 30 of the invention in which a sheeting 20 is applied to one surface 30U or 30L of the ceiling fan blade 30 to extend onto the angled edge portions 36 and 38 of that surface to leave exposed the rounded edge portions 32, 34. FIG. 10 illustrates the eighth embodiment of the ceiling fan 30 of the invention in which a sheeting 20 is applied to one surface 30U or 30L of the ceiling fan blade 30 to extend onto the angled edge portions 36 and 38 of that surface and around the rounded edge portions 32, 34.

As shown in FIGS. 9 and 10 with the sheeting 20 applied to only to one surface 30U or 30L, the exposed rounded edge portions 32, 34 (FIG. 9) and the exposed edge portions 36 and 38 of the other surface 30L or 30U (FIGS. 9 and 10) are then coated with a sealant to prevent any moisture ingress into the ceiling fan blade 30. More specifically, as shown in FIG. 10 with the sheeting applied to only one surface (e.g., 30U), but not the other surface (e.g., 30L), the exposed rounded edge portion 32, 34 as well as the exposed angled edge portion 38 of the other surface 30L, are coated with the sealant to prevent any moisture ingress along the thin edge of the fan blade 30. It is noted that the exposed surface (e.g. 30U) of the fan blade 30 that is not covered with the sheeting 20 may likewise be coated with a sealant to prevent moisture ingress into the ceiling fan 30.

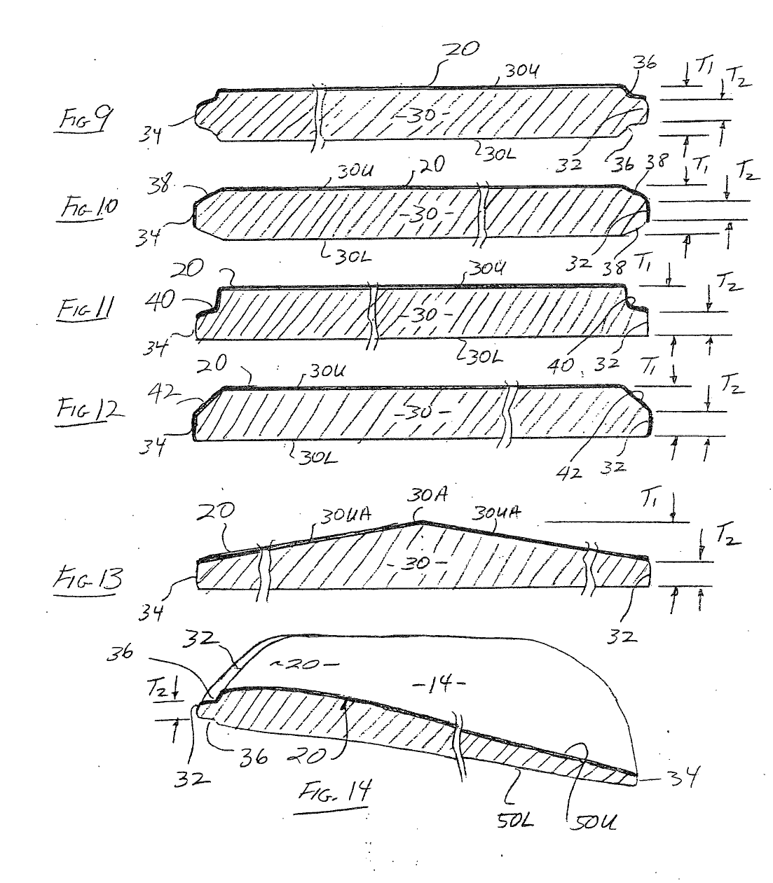

Similarly, with respect to FIG. 11 in which the rounded edge portion 32, 34 extends along one side (e.g. 30L) to define only one angled edge portion 40, the sheeting 20 is applied to the other surface (e.g. 30U) to extend across the entire surface thereof and onto the angled edge portion 40. The rounded edge portion 32, 34 left exposed may be coated with a moisture sealant to prevent any moisture from being absorbed by the ceiling fan blade 30. In FIG. 12, the sheeting 20 extends over the angled edge portion 42 and around the rounded edge portion 32, 34 thereby obviating the need for a sealant.

With regard to FIG. 13, the sheeting 20 may be applied over the apex surface 30UA to extend across the entire surface thereof up to the rounded edge portion 32, 34.

For curvilinear ceiling fan blades as shown in FIG. 14 which may be configured with any of the edge embodiments of FIGS. 3-6, the sheeting 20 may be applied across the upper surface 50U to extend onto at the angled edge portion 36.

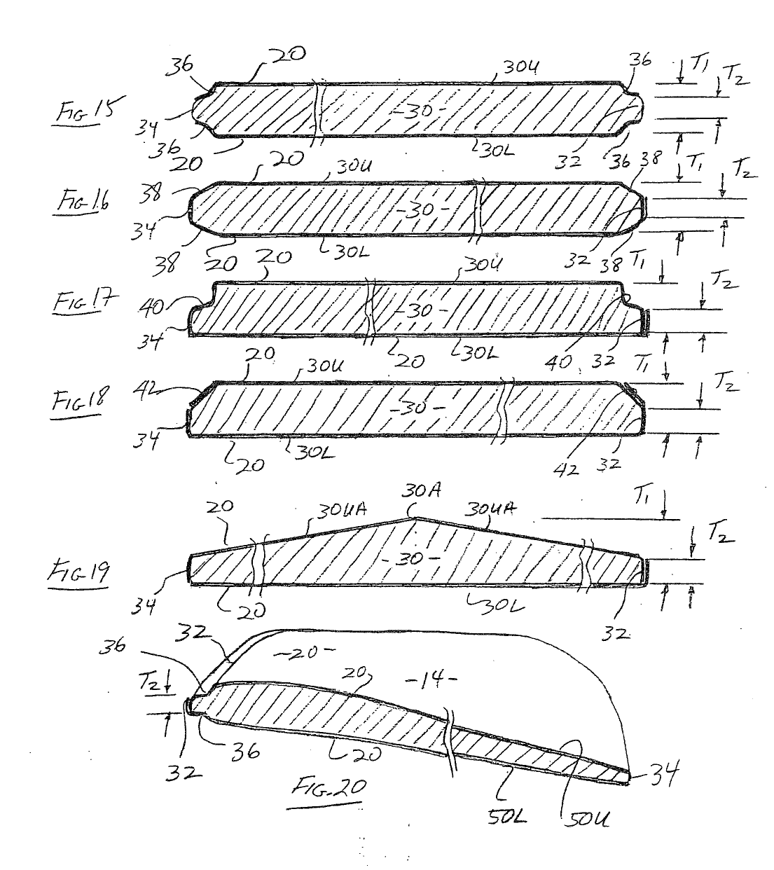

Still other embodiments of the ceiling fan 30 of the invention are shown in FIGS. 15-20. Corresponding to FIGS. 9-14, respectively, the embodiments of FIGS. 15-20 include sheeting 20 which is applied to both surfaces 30U and 30L of the ceiling fan blade 30. In regard to the symmetrical embodiment of FIG. 15, the sheeting 20 may extend over the respective angled edge portions 36 leaving the rounded edge portion 32, 34 exposed, to then be sealed as described above. Alternatively, as shown in the other symmetrical embodiment of FIG. 16, the sheeting 20 applied to both surfaces 30U and 30L of the ceiling fan blade 30 may extend beyond the angled edge portions 38 around onto the rounded edge portions 32, 34 in either an overlapping manner (see right edge portion 32) or an abutting relationship (see left edge portion 34).

With regard to the non-symmetrical embodiment of FIG. 17, the sheeting 20 may be applied to one surface 30U or 30L to extend over the angled edge portion 40 and around the rounded portion 32, 34 whereas the other sheeting 20 applied to the other surface 30L or 30U may be simply applied to that surface to extend in an overlapping relationship (see right edge portion 32) or an abutting relationship (see left edge portion 34) with respect to the sheeting 30 from the first surface 30U or 30L. Likewise, in the non-symmetrical embodiment of FIG. 18, the sheeting 20 may be applied to both surfaces 30U and 30L to extend over the angled edge portion 42 and overlap each other along the rounded edge portion 32, 34.

The apex embodiment of FIG. 19 may include similarly-applied sheeting 20 to the upper and lower surfaces 30U and 30L and the rounded edge portion 32, 24, to either overlap (see right rounded edge portion 32) or abut (see left rounded edge portion 34) each other.

Finally, in the curvilinear ceiling fan blade 14, the sheeting 20 may be applied to both surfaces 50L and 50U to extend over their respective angled side portions 36 and the rounded edge portion 32, 34 to either overlap (see left rounded edge portion 32) or abuts (see right rounded edge portion 34) each other.

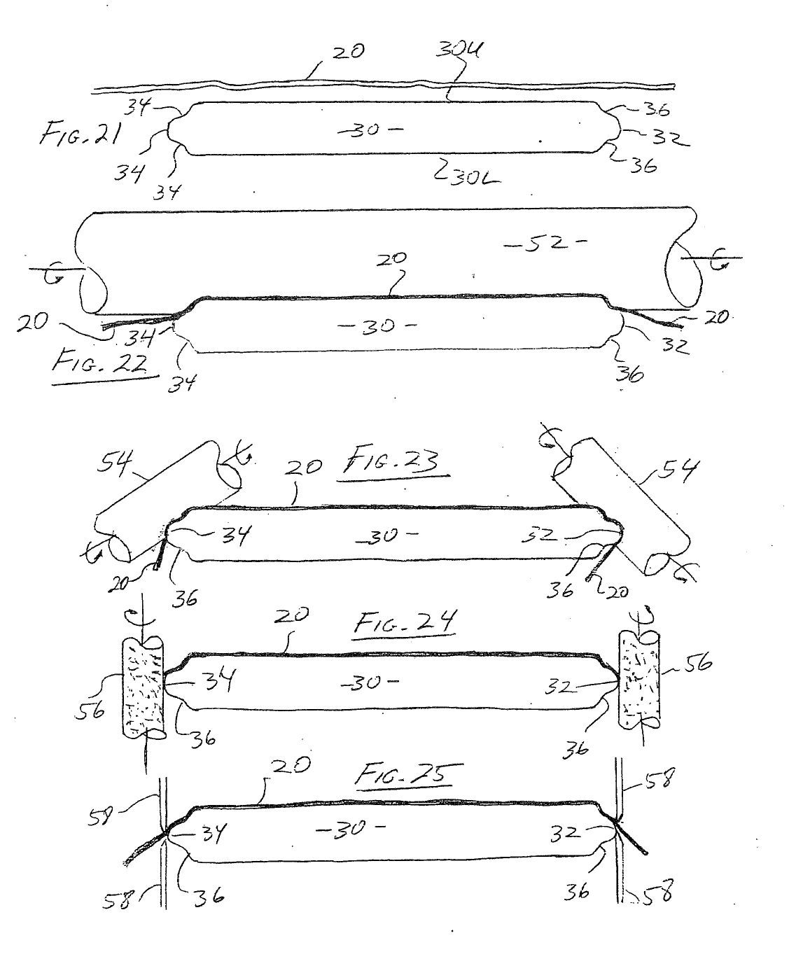

Without departing from the spirit and scope of this invention, as noted previously, the ceiling fan blades 30 may be manufactured from any available technique, with or without the sheeting 20 (e.g., vinyl or paper) on one or both of the surfaces 30U and 30L thereof and with or without sealing of the exposed longitudinal edges 32 and 36-42 thereof. However, preferred manufacturing methods are illustrated in FIGS. 21-28.

As shown in FIG. 21, an over-sized sheet of sheeting 20 is adhesively applied to one of the surfaces 30U or 30L of the ceiling fan blade 30. The adhesive application may comprise an adhesive that is applied to the mating surfaces 30U or 30L of the ceiling fan blade 30 and/or the sheeting 20, or the sheeting 20 may comprise a self-adhesive surface for adherence to the fan blade surfaces 30U or 30L.

As shown in FIG. 22, pressure is applied to the sheeting to forcibly apply the sheeting 20 to the respective surface 30U or 30L of the ceiling fan blade 30. Preferably, the pressure is applied by passing the ceiling fan blade 30 with the applied sheeting 20 under a compression roller 52 that is composed of a resilient material such that the sheeting 20 is firmly pressed onto the surface 30U or 30L of the ceiling fan blade 30 without any trapped air that might otherwise create air bubbles. Moreover, the resiliency of the roller 52 is such that the sheeting 20 is pressed along the angled edge portions 36-42 as the ceiling fan blade 30 passes under the roller 52.

It is noted that the foregoing is most applicable to the embodiments of FIGS. 9, 11, 13, 14 and 15 in which the sheeting 20 extends only onto the angled edge portions 36-42 but not onto the rounded edge portions 32, 34. With regard to the embodiments of FIGS. 10, 12, 16, 17, 18, 19 and 20, in which the sheeting 20 extends also around onto the rounded edge portions 32, 34, a further manufacturing step comprises, as shown in FIG. 23, the additional application of an edge rollers 54 to assure that the sheeting 20 is firmly affixed to the rounded edge portions 32, 34. While the edge roller 54 may comprise a simple hand-operated edge 54 roller operated by a factory worker, preferably, the edge roller 54 comprises fixed side rollers 54 between which the ceiling fan blade 30 is passed to press the sheeting 20 onto the rounded edge portions 32, 34.

Due to the over-sized configuration of a sheeting 20, it is noted that the sheeting 20, once applied, will have excess edges that extend beyond the edge of the ceiling fan blade (see FIGS. 22 and 23). As shown in FIG. 24, the excess sheeting 20 may be trimmed by a sanding operation against a rotary sander 56 or, as shown in FIG. 25, by an edge cutter instrument 58.

With respect to the embodiments of FIG. 15 in which the sheeting 20 is applied to both of the surfaces 30U and 30L of the fan blade 30 and onto the edge portions 36-42 but not around the rounded edge portions 32, 34, the application step of FIG. 21 would include application of the sheeting to both surfaces 30U and 30L followed by the pressing step of FIG. 22 and the trimming step of 24 and 25. With respect to the embodiments of FIGS. 16-20 in which the sheeting 20 is applied to both of the surfaces 30U and 30L of the fan blade 30 and onto the edge portions 36-42 and then around the rounded edge portions 32, 34 to an overlapping or abutting relationship, the pressing step of FIG. 22 and the trimming step of FIGS. 24 and 25 may be performed with respect to one surface 30U or 30L and then repeated for the other surface 30L or 30U.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. A ceiling fan comprising in combination:
a motor having a rotatable rotor;
a plurality of ceiling fan blades comprising two sides having a thickness therebetween, said blades being connected to said rotor to rotate therewith;
each of said ceiling fan blades comprising a thin edge along its leading edge having an angled edge portion and a rounded edge portion, said rounded edge portion being thinner than said thickness of said ceiling fan blade to present less resistance and produce less turbulence and achieves high efficiencies; and
a sheeting applied to at least one of said sides and to at least said angled edge portion.

2. The ceiling fan as set forth in claim 1, wherein said sheeting is applied to extend beyond said rounded edge portion onto said rounded edge portion.

3. The ceiling fan as set forth in claim 1, wherein said sheeting is applied to both said sides.

4. The ceiling fan as set forth in claim 3, wherein said sheeting is applied to extend from said sides beyond said rounded edge portion onto said rounded edge portion.

5. The ceiling fan as set forth in claim 4, wherein said sheeting extends from both sides onto said rounded edge portion overlaps each other.

6. The ceiling fan as set forth in claim 1, wherein said ceiling fan blades each comprises a generally planar elongated configuration.

7. The ceiling fan as set forth in claim 1, wherein said ceiling fan blades each comprises a generally curvilinear elongated configuration.

8. The ceiling fan as set forth in claim 1, wherein said rounded edge portion of each of said ceiling fan blades is at least as great and as an industry standard minimum thickness for leading edges of ceiling fan blades.

9. The ceiling fan as set forth in claim 1, wherein said angled edge portion gradually tapes from said rounded edge portion into said thickness of said ceiling fan blade.

10. The ceiling fan as set forth in claim 1, wherein said angled edge portion steps from said rounded edge portion into said thickness of said ceiling fan blade.

11. The ceiling fan as set forth in claim 9, wherein said rounded edge portion is centered relative to said thickness of said blade.

12. The ceiling fan as set forth in claim 9, wherein said rounded edge portion is positioned at one surface of said fan blade and wherein said angled edge portion extends from an opposite surface of said fan blade to said rounded edge portion.

13. The ceiling fan as set forth in claim 9, wherein said rounded edge portion is positioned at a lower surface of said fan blade.

14. The ceiling fan as set forth in claim 1, wherein each fan blade comprises an upper surface having a generally apex configuration defined by two planar surfaces formed at an angle leading form the opposing leading edges across the width of said fan blade to form an apex along a center line of the fan blade.

15. The ceiling fan as set forth in claim 14, wherein said rounded edge portion comprises a reduced thickness which is equal to or appreciably greater than the minimum thickness mandated by applicable ceiling fan safety regulations.

16. A fan blade comprising a thin leading edge having an angled portion and a rounded portion, at least one surface of said fan blade comprising a sheeting that extends over said angled edge portion.

17. The ceiling fan as set forth in claim 16, wherein said angled edge portion comprises a concave step.

18. The ceiling fan as set forth in claim 13, wherein said angled portion comprises a generally plan transition.

19. The ceiling fan as set forth in claim 13, wherein said rounded edge portion is positioned closer to a bottom surface of said fan blade and wherein said angled portion extends between said thin leading edge and an upper surface of said fan blade.

20. The ceiling fan as set forth in claim 16, comprising a generally apex configuration wherein an upper surface of said fan blade comprises two angled surfaces extending from opposing thin leading edges to a longitudinal apex.

21. The ceiling fan as set forth in claim 16, comprising a generally planar ceiling fan blade with its opposing surfaces being generally parallel to each other.

22. The ceiling fan as set forth in claim 16, comprising a curvilinear ceiling fan blade.

23. A method for manufacturing a fan blade having opposing surfaces and a thin edge comprising an angled edge portion and a rounded edge portion, comprising the step of applying a sheeting to at least one of said opposing surfaces to extend over at least said angled edge portion.

24. The method as set forth in claim 23, wherein the step of applying the sheeting comprises applying the sheeting to extend over said angled edge portion onto said rounded edge portion.

25. The method as set forth in claim 23, wherein said step of applying said sheeting comprises applying said sheeting to both surfaces.
